(19) United States
(12) Patent Application Publication
(10) Pub. No.: US 2015/0149593 A1
(43) Pub. Date: May 28, 2015

(54) VIRTUAL DESKTOP INFRASTRUCTURE SERVER, COMPUTER IMPLEMENTED VIDEO STREAMING METHOD, AND NON-TRANSITORY COMPUTER READABLE STORAGE MEDIUM THEREOF

(71) Applicant: Institute For Information Industry, Taipei (TW)

(72) Inventors: Ching-Ju LIN, Taipei City (TW); Yu-Chin TSAI, New Taipei City (TW); Shan CHIN, New Taipei City (TW)

(73) Assignee: Institute For Information Industry, Taipei (TW)

(21) Appl. No.: 14/092,593

(22) Filed: Nov. 27, 2013

(51) Int. Cl. H04L 29/08

(52) U.S. Cl. CPC H04L 67/06
USPC 709/219

(57) ABSTRACT

A virtual desktop infrastructure server, computer implemented video streaming method, and non-transitory computer readable storage medium thereof are provided. The virtual desktop infrastructure server includes a network interface, an adaptive frame filter, and a virtual desktop infrastructure layer. The adaptive frame filter determines that a bandwidth between the network interface and a client device is below a predetermined threshold and receive an original packet of a video. The original packet comprises a plurality of frames, wherein each of the frames comprises a base layer and an enhancement layer. The adaptive frame filter generates a processed packet by dropping the enhancement layer of at least one of the frames. The virtual desktop infrastructure layer generates a virtual desktop infrastructure packet according to the processed packet. The network interface transmits the virtual desktop infrastructure packet via a video channel to the client device.

### FIELD

The present invention relates to virtual desktop infrastructure server, computer implemented video streaming method, and non-transitory computer readable storage medium thereof; more particularly, the present invention relates to virtual desktop infrastructure server, computer implemented video streaming method, and non-transitory computer readable storage medium thereof that provides adaptive video streaming services.

### BACKGROUND

Virtual Desktop Infrastructure (VDI), such as Remote Desktop Protocol (RDP), is a remote server that has user desktop environments and can be accessed by client devices, which is illustrated in FIG. 1. The client device 13 can access services provided by the VDI server 11 or access services on other sites via the VDI server 11.

When adopting VDI in video streaming technology, one critical problem that has to be faced is the network congestion. According to prior video streaming technology, frames of a video are dropped randomly when the network between the VDI server 11 and the client device 13 is congested. Since frames are dropped randomly, the dropped frames may be important ones (such as a frame being dependent by other frames). When an important frame is dropped, the video decoded at the client device 13 will have unsatisfied visual quality. According to the above descriptions, for VDI, there is still an urgent need for a video streaming technology that can provide good visual quality when the network is congested.

### SUMMARY

To solve the aforementioned problems of the prior arts, certain embodiments of the present invention provide a virtual desktop infrastructure server, computer implemented video streaming method, and non-transitory computer readable storage medium thereof.

The virtual desktop infrastructure server of certain embodiments of the present invention comprises a network interface, an adaptive frame filter, and a virtual desktop infrastructure layer. The adaptive frame filter is configured to determine that a bandwidth between the network interface and a client device is below a threshold and receive an original packet of a video. The original packet comprises a plurality of frames, wherein each of the frames comprises a base layer and an enhancement layer. The adaptive frame filter is further configured to generate a processed packet by dropping the enhancement layer of at least one of the frames. The virtual desktop infrastructure layer is configured to generate a virtual desktop infrastructure packet according to the processed packet. The network interface is configured to transmit the virtual desktop infrastructure packet via a video channel to the client device.

The computer implemented video streaming method of certain embodiments of the present invention comprises the following steps of: (a) determining that a bandwidth between a network interface and a client device is below a threshold, (b) receiving an original packet of a video, wherein the original packet comprises a plurality of frames and each of the frames comprises a base layer and an enhancement layer, (c) generating a processed packet by dropping the enhancement layer of at least one of the frames, (d) generating a virtual desktop infrastructure packet according to the processed packet, and (e) transmitting the virtual desktop infrastructure packet via a video channel to the client device.

The non-transitory computer readable storage medium of certain embodiments of the present invention includes a computer program stored therein. The computer program executes a video streaming method after being loaded into a computing apparatus. The video streaming method comprises the following steps of: (a) determining that a bandwidth between a network interface and a client device is below a threshold, (b) receiving an original packet of a video, wherein the original packet comprises a plurality of frames and each of the frames comprises a base layer and an enhancement layer, (c) generating a processed packet by dropping the enhancement layer of at least one of the frames, (d) generating a virtual desktop infrastructure packet according to the processed packet, and (e) transmitting the virtual desktop infrastructure packet via a video channel to the client device.

The present invention, according to certain embodiments, can adaptively generate the virtual desktop infrastructure packets for the client device according to the bandwidth between the virtual desktop infrastructure server and the client device. When the bandwidth is below the predetermined threshold, the enhancement layer of at least one frame will be dropped. To achieve a better peak signal noise ratio, the frame that being dropped its enhancement layer is a frame that is not dependent by the rest of the frames. With the above technical features, the important frames (i.e. the frames that are dependent by other frames) of a video will not be dropped. Consequently, the quality of the video at the client device will not be seriously degraded when the bandwidth is below the predetermined threshold.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional virtual desktop infrastructure;

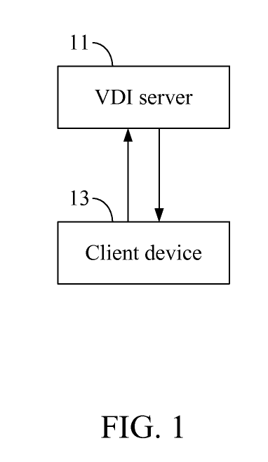

FIG. 2A illustrates a VDI server in the first embodiment of the present invention;

FIG. 2B illustrates the original packet 26a in the first embodiment;

FIG. 3 illustrates a VDI server in the second embodiment of the present invention; and

FIG. 4 illustrates a flowchart of the third embodiment of the present invention.

### DETAILED DESCRIPTION

In the following descriptions, a virtual desktop infrastructure (VDI) server, computer implemented video streaming method, and non-transitory computer readable storage medium thereof will be explained with reference to example embodiments thereof. However, these example embodiments are not intended to limit the present invention to any examples, embodiments environments, applications, or implementations described in these example embodiments. Therefore, the description of these example embodiments is only for the purpose of illustration rather than to limit the scope of the present invention. It shall be appreciated that in the following embodiments and attached drawings, elements not directly related to the present invention are omitted from depiction.

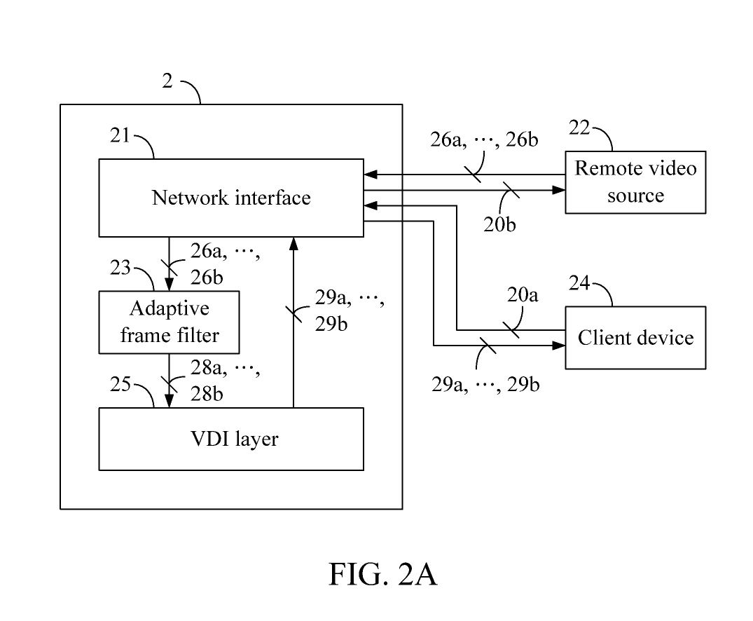

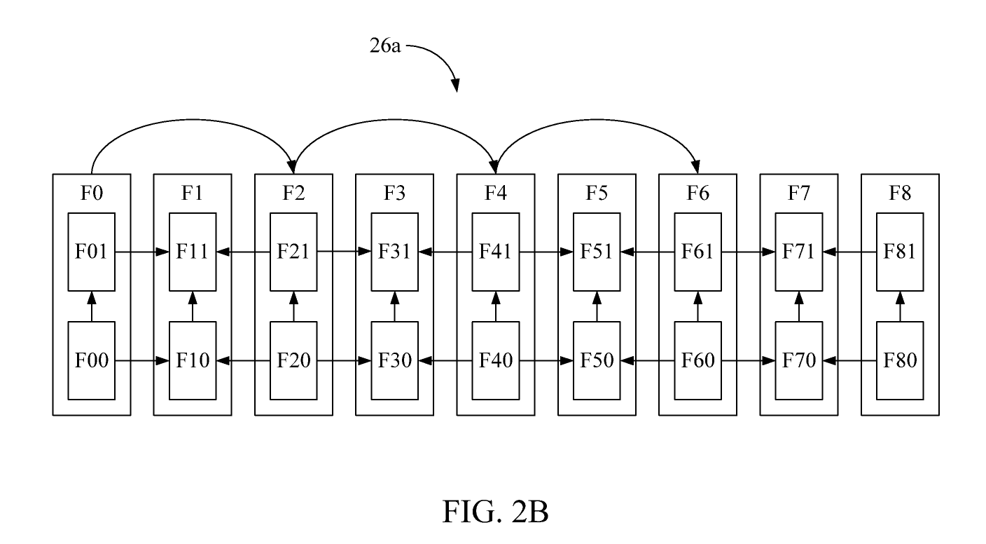

A first embodiment of the present invention is a VDI server 2 and a schematic view of which is illustrated in FIG. 2A. The VDI server 2 comprises a network interface 21, an adaptive frame filter 23, and a VDI layer 25. The adaptive frame filter 23 is electrically connected to the network interface 21 and the VDI layer 25. The VDI layer is electrically connected to the network interface 21. The network interface 21 may be any interface that can receive and transmit data through various kinds of network. The adaptive frame filter 23 and the VDI layer 25 may be realized by any of various processors, central processing units (CPUs), microprocessors, or other computing devices well known to those of ordinary skill in the art.

In this embodiment, a client device 24 requests a video stored in a remote video source 22 via the VDI server 2. Specifically, the client device 24 transmits a request signal 20a for the video to the VDI server 2. The network interface 21 receives the request signal 20a from the client device 24 and then transmits another request signal 20b to the remote video source 22 in response to the receiving of the request signal 20a. The remote video source 22 continuously transmits a plurality of original packets 26a, . . . , 26b of the video to the VDI server 2 after receiving the request signal 20b. The network interface 21 receives the original packets 26a, . . . , 26b from the remote video source 22, while the adaptive frame filter 23 receives the original packets 26a, . . . , 26b from the network interface 21.

In this embodiment, when processing any of the original packets 26a, . . . , 26b, the adaptive frame filter 23 will determine whether a bandwidth between the network interface 21 and the client device 24 is below a predetermined threshold (not shown). It is noted that the bandwidth between the network interface 21 and the client device 24 may be calculated periodically or non-periodically, which should be familiar to people ordinary skilled in the art.

For convenience, it is assumed that the adaptive frame filter 23 determines that the bandwidth between the network interface 21 and the client device 24 is below the predetermined threshold when processing the original packet 26a. Please refer to FIG. 2B, which illustrates the original packet 26a. The original packet 26a comprises a plurality of frames F0, F1, F2, F3, F4, F5, F6, F7, F8, wherein the frames F0, F1, F2, F3, F4, F5, F6, F7, F8 respectively comprise a base layer F00, F10, F20, F30, F40, F50, F60, F70, F80 and an enhancement layer F01, F11, F21, F31, F41, F51, F61, F71, F81. It is noted that the present invention does not limit the number of the frames comprised in a packet. Since the bandwidth between the network interface 21 and the client device 24 is below the predetermined threshold, the adaptive frame filter 23 generates a processed packet 28a by dropping the enhancement layer of at least one of the frames F0, F1, F2, F3, F4, F5, F6, F7, F8.

In some other embodiments, the frame that being dropped its enhancement layer has a special characteristic in order to achieve a better peak signal noise ratio (PSNR). To be more specific, the adaptive frame filter 23 selects at least one selected frame from the frames F0, F1, F2, F3, F4, F5, F6, F7, F8, wherein the at least one selected frame is not dependent by the rest of the frames, and the dropped enhancement layer is the enhancement layer of the at least one selected frame.

Please refer to FIG. 2B again, which illustrates the dependencies of the frames F0, F1, F2, F3, F4, F5, F6, F7, F8. Taking the frame F1 for example, the frame F1 depends on the frame F0 and the frame F2, which means that the frame F1 can be correctly decoded only when information of both the frame F0 and the frame F2 is derived. Taking the frame F6 as another example, the frame F6 depends on the frame F4, which means that the frame F6 can be correctly decoded only when information of the frame F4 is derived. Taking the enhancement layer F71 as an example, the enhancement layer F71 depends on the base layer F70, which means that the enhancement layer F71 can be correctly decoded only when information of the base layer F70 is derived. In the case shown in FIG. 2B, the frames F1, F3, F5, F7 are not dependent by other frames. Hence, the adaptive frame filter 23 may select the frame F1, the frame F3, the frame F5, and/or the frame F7 as the at least one selected frame and then drop the enhancement layer of the at least one selected frame.

If the video conforms to Moving Picture Experts Group (MPEG)-4, H.264, or Scalable Video Coding (SVC) standard, the above frames F0, F8 are I frames, the above frames F2, F4, F6 are P frames, and the above frames F1, F3, F5, F7 are B frames. The at least one selected frames may be one or more of the B frames.

After the adaptive frame filter 23 generates the processed packet 28a by dropping the enhancement layer of at least one of the frames F0, F1, F2, F3, F4, F5, F6, F7, F8, the VDI layer 25 generates a VDI packet 29a according to the processed packet 28a. It is noted the VDI packet 29a conforms to the requirements of a video channel. Afterwards, the network interface 21 transmits the VDI packet 29a via the video channel to the client device 24.

Later, the VDI server 2 needs to process the original packet 26b received from the remote video source 22. For convenience, it is assumed that the adaptive frame filter 23 determines that the bandwidth between the network interface 21 and the client device 24 is not below the predetermined threshold when processing the original packet 26b. Since the bandwidth between the network interface 21 and the client device 24 is not below the predetermined threshold, the adaptive frame filter 23 generates a processed packet 28b without dropping any layers of the frames comprised in the original packet 26b. After the adaptive frame filter 23 generates the processed packet 28b, the VDI layer 25 generates a VDI packet 29b according to the processed packet 28b. It is noted the VDI packet 29b conforms to the requirements of the video channel. Afterwards, the network interface 21 transmits the VDI packet 29b via the video channel to the client device 24.

From the viewpoint of the client device 24, the VDI packets 29a, . . . , 29b can be processed and decoded by the mechanism provided by the prior art. Briefly speaking, the client device 24 comprises a VDI layer (not shown) and a video encoder (not shown). After the client device 24 receives the VDI packets 29a, . . . , 29b, the video decoder of the client device 24 then decodes processed packets 29a, . . . , 29b.

In some other embodiments, the VDI server 2 may be specialized to a remote desktop protocol (RDP) server. For those embodiments, the VDI layer 25 is specialized to an RDP layer and the VDI packets 29a, . . . , 29b are specialized to RDP packets.

According to the above descriptions, VDI server 2 can adaptively generate the VDI packets 29a, . . . , 29b for the client device 24 according to the bandwidth between the VDI server 2 and the client device 24. Particularly, when the bandwidth is determined to be below the predetermined threshold, the enhancement layer of at least one frame will be dropped. To achieve a better PSNR, the frame that being dropped its enhancement layer is a frame that is not dependent by the rest of the frames. With the above technical features, the important frames (i.e. the frames that are dependent by other frames) of a video will not be dropped. Consequently, the quality of the video at the client device 24 will not be seriously degraded when the bandwidth is below the predetermined threshold.

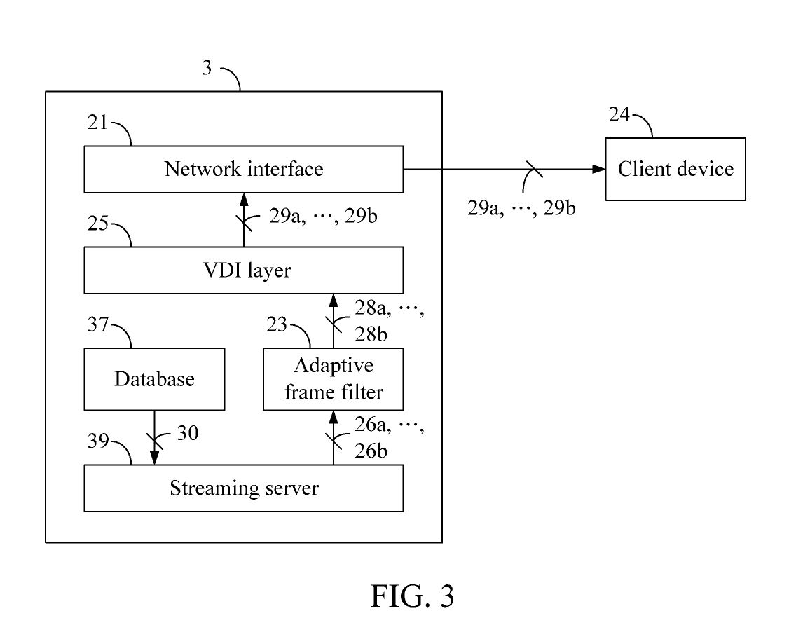

A second embodiment of the present invention is a VDI server 3 and a schematic view of which is illustrated in FIG. 3. The VDI server 3 comprises a network interface 21, an adaptive frame filter 23, a VDI layer 25, a database 37, and a streaming server 39. The database 37 may be a memory, a floppy disk, a hard disk, a compact disk (CD), a mobile disk, a magnetic tape, a database, or any other storage media that can store data/information. The streaming server 39 may be realized by any of various processors, central processing units (CPUs), microprocessors, or other computing devices well known to those of ordinary skill in the art. The VDI layer 25 is electrically connected to the network interface 21 and the adaptive frame filter 23. The streaming server 39 is electrically connected to the database 37 and the adaptive frame filter 23. In this embodiment, the video is stored in the database 37. The streaming server 39 generates the original packets 26a, . . . , 26b of the video. Afterwards, the adaptive frame filter 23 receives the original packets 26a, . . . , 26b from the streaming server 39. After receiving the original packets 26a, . . . , 26b, the adaptive frame filter 23, the VDI layer 25, and the network interface 21 perform the same operations as those described in the first embodiment.

Briefly speaking, the adaptive frame filter 23 generates the processed packets 28a, . . . , 28b from the original packets 26a, . . . , 26b according to the bandwidth between the network interface 21 and the client device 24. When the bandwidth is below a predetermined threshold, the adaptive frame filter 23 generates a processed packet by dropping the enhancement layer of at least one of the frames. On the contrary, when the bandwidth is not below a predetermined threshold, the adaptive frame filter 23 generates the processed packet without dropping any layer of any frame.

After the adaptive frame filter 23 generates the processed packets 28a, . . . , 28b, the VDI layer 25 generates the VDI packets 29a, . . . , 29b according to the processed packets 28a, . . . , 28b respectively. The network interface 21 transmits the VDI packet 29a, . . . , 29b via the video channel to the client device 24. From the viewpoint of the client device 24, the VDI packets 29a, . . . , 29b can be processed and decoded by the mechanism provided by the prior art.

According to the above descriptions, when the video is stored in the VDI server 3, the VDI server 3 can also adaptively generate the VDI packets 29a, . . . , 29b for the client device 24 according to the bandwidth between the VDI server 3 and the client device 24. Consequently, the quality of the video at the client device 24 will not be seriously degraded when the bandwidth is below the predetermined threshold.

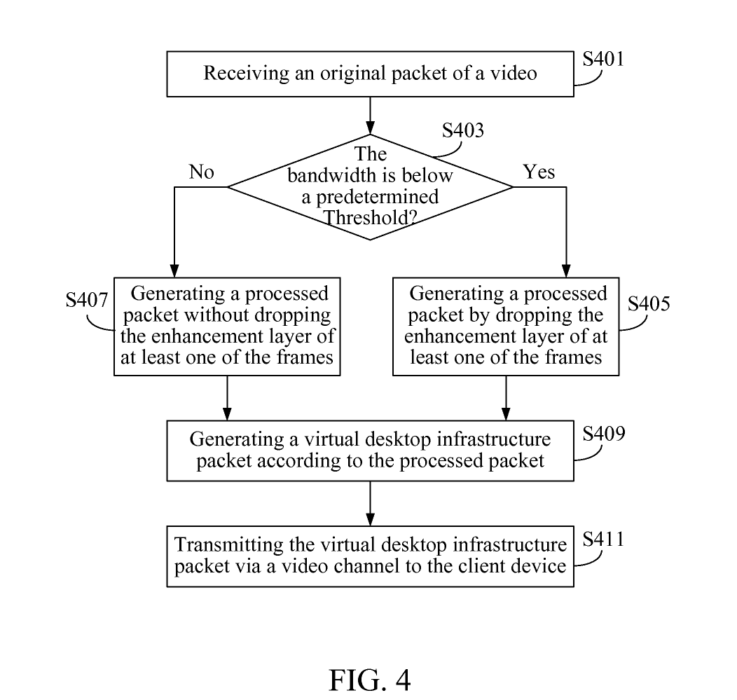

A third embodiment is a computer implemented video streaming method, which can be executed by a computing apparatus (e.g. the VDI servers 2, 3 in the first and second embodiments). The flowchart of the third embodiment is illustrated in FIG. 4.

First, step S401 is executed to receive an original packet of a video, wherein the original packet comprises a plurality of frames and each of the frames comprises a base layer and an enhancement layer. The step S401 may receive the original packet of the video from one of a database and a streaming server. Next, step S403 is executed to determine whether a bandwidth between a network interface and a client device is below a predetermined threshold.

If the step S403 determines that the bandwidth between the network interface and the client device is below the predetermined threshold, then step S405 is executed to generate a processed packet by dropping the enhancement layer of at least one of the frames. After the step S405, step S409 is executed for generating a virtual desktop infrastructure packet according to the processed packet. Next, step S411 is executed for transmitting the virtual desktop infrastructure packet via a video channel to the client device.

In some other embodiments, the computer implemented video streaming method may further execute a step (not shown) before step S405 for selecting a selected frame from the frames, wherein the selected frame is not dependent by the rest of the frames. For these embodiments, the dropped enhancement layer is the enhancement layer of the selected frame. Particularly, when the video conforms to MPEG-4, H.264, or SVC standard, the frames comprise an I frame, a P frame, and a B frame, the selected frame is the B frame, and the dropped enhancement layer is the enhancement layer of the B frame.

If the step S403 determines that the bandwidth between the network interface and the client device is not below the predetermined threshold, then step S407 is executed to generate a processed packet without dropping the enhancement layer of at least one of the frames. Similarly, after the step S407, step S409 and step S411 are executed.

In addition to the aforesaid steps, the third embodiment can also execute all the operations and functions set forth in the first and second embodiments. How the third embodiment executes these operations and functions will be readily appreciated by those of ordinary skill in the art based on the explanation of the first and second embodiments, and thus will not be further described herein.

The computer implemented video streaming method described in the third embodiment may be implemented by a computer program having a plurality of codes. The computer program is stored in a non-transitory computer readable storage medium. When the codes are loaded into a computing apparatus (e.g. the VDI servers 2, 3 in the first and second embodiments), the computer program executes the computer implemented video streaming method as described in the third embodiment. The non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the present invention can adaptively generate the virtual desktop infrastructure packets for the client device according to the bandwidth between the virtual desktop infrastructure server and the client device. When the bandwidth is below the predetermined threshold, the enhancement layer of at least one frame will be dropped. To achieve a better peak signal noise ratio, the frame that being dropped its enhancement layer is a frame that is not dependent by the rest of the frames. With the above technical features, the important frames (i.e. the frames that are dependent by other frames) of a video will not be dropped. Consequently, the quality of the video at the client device will not be seriously degraded when the bandwidth is below the predetermined threshold.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A virtual desktop infrastructure server, comprising:
a network interface;
an adaptive frame filter, being configured to determine that a bandwidth between the network interface and a client device is below a predetermined threshold and receive an original packet of a video, wherein the original packet comprises a plurality of frames, each of the frames comprises a base layer and an enhancement layer, and the adaptive frame filter is further configured to generate a processed packet by dropping the enhancement layer of at least one of the frames; and
a virtual desktop infrastructure layer, being configured to generate a virtual desktop infrastructure packet according to the processed packet;
wherein the network interface is configured to transmit the virtual desktop infrastructure packet via a video channel to the client device.

2. The virtual desktop infrastructure server of claim 1, further comprising:
a database, being configured to store the video; and
a streaming server, being configured to generate the original packet of the video;
wherein the adaptive frame filter receives the original packet from the streaming server.

3. The virtual desktop infrastructure server of claim 1, wherein the network interface further receives the original packet of the video from a remote video resource.

4. The virtual desktop infrastructure server of claim 1, wherein the adaptive frame filter selects a selected frame from the frames, wherein the selected frame is not dependent by the rest of the frames, and the dropped enhancement layer is the enhancement layer of the selected frame.

5. The virtual desktop infrastructure server of claim 4, wherein the frames comprise an I frame, a P frame, and a B frame, and the selected frame is the B frame.

6. A computer implemented video streaming method, comprising the steps of:
determining that a bandwidth between a network interface and a client device is below a predetermined threshold;
receiving an original packet of a video, wherein the original packet comprises a plurality of frames and each of the frames comprises a base layer and an enhancement layer;
generating a processed packet by dropping the enhancement layer of at least one of the frames;
generating a virtual desktop infrastructure packet according to the processed packet; and
transmitting the virtual desktop infrastructure packet via a video channel to the client device.

7. The computer implemented video streaming method of claim 6, wherein the receiving step receives the original packet of the video from one of a database and a streaming server.

8. The computer implemented video streaming method of claim 6, further comprising the step of:
selecting a selected frame from the frames, wherein the selected frame is not dependent by the rest of the frames;
wherein the dropped enhancement layer is the enhancement layer of the selected frame.

9. The computer implemented video streaming method of claim 8, wherein the frames comprise an I frame, a P frame, and a B frame, and the selected frame is the B frame.

10. A non-transitory computer readable storage medium, having a computer program stored therein, the computer program executing a video streaming method after being loaded into a computing apparatus, the video streaming method comprising the steps of:
determining that a bandwidth between a network interface and a client device is below a threshold;
receiving an original packet of a video, wherein the original packet comprises a plurality of frames and each of the frames comprises a base layer and an enhancement layer;
generating a processed packet by dropping the enhancement layer of at least one of the frames;
generating a virtual desktop infrastructure packet according to the processed packet; and
transmitting the virtual desktop infrastructure packet via a video channel to the client device.
